(19) United States
(12) Patent Application Publication
(10) Pub. No.: US 2008/0236127 A1
(43) Pub. Date: Oct. 2, 2008

(54) LOW-BUSH BERRY HARVESTING SYSTEM AND METHOD

(76) Inventor: Gerard COUTURE, Saint-Felicien (CA)

Correspondence Address: OGILVY RENAULT LLP, 1981 MCGILL COLLEGE AVENUE, SUITE 1600, MONTREAL, QC, H3A2Y3, CA

(21) Appl. No.: 12/054,844

(22) Filed: Mar. 25, 2008

Related U.S. Application Data
(60) Provisional application No. 60/908,486, filed on Mar. 28, 2007.

(51) Int. Cl. A01D 46/00

(52) U.S. Cl. 56/330

(57) ABSTRACT

The low-bush berry harvester that has a plurality of interspaced berry-picking units movable along a closed-loop berry-picking path. The closed-loop berry picking path is non-circular, but rather designed with a relatively straight lower portion configured and adapted to be level with the ground during use. Hence, the berry-picking units are slidable against the ground in the straight lower portion of the berry-picking path to pick berries, and are pivotable in an upper portion of the berry-picking path to drop picked berries for collection.

### CROSS-REFERENCE TO RELATED APPLICATION

This application claims priority of U.S. provisional application No. 60/908,486, entitled “Low-Bush Berry Harvester”, filed Mar. 28, 2007 by applicant, the contents of which are hereby incorporated by reference.

### FIELD

The present specification generally relates to a harvester particularly adapted to harvesting low-bush berries such as low-bush blueberries, for example.

### BACKGROUND

During many past decades, the wild blueberry has been hand harvested with a metal rake similar to the cranberry scoop. Because harvesting the blueberry fruit constitutes one of the major expenses in producing the crop, there has been manifested interest in the last decade of reducing these costs by mechanical harvesting.

One known mechanical blueberry harvester uses steel teeth combs on a rotating head. The frame is carried by a tractor. When the frame rotates, the combs rotationally travel in a circular motion. The combs progressing in the lower portion of the circle move in the rear direction, opposite the displacement of the tractor. While the harvester is displaced in a forward longitudinal direction of displacement over a blueberry field, the berry-picking combs successively engage blueberry bushes and pick the blueberries therefrom. The blueberries are eventually discharged onto a lateral, longitudinal conveyor, which takes them to the rear of the tractor, where they are discharged into baskets.

Although this type of blueberry harvester has been found satisfactory to a certain degree, there remains room for improvements.

### SUMMARY

In accordance with one aspect, there is provided A low-bush berry harvester which has berry-picking units which are successively and cyclically slid against, or adjacent to, the ground, along a predetermined distance, in a substantially horizontal lower portion of a berry picking path, where they engage the low-bush berry bushes. Henceforth, the berry-picking path is non-circular, but has a substantially linear portion at a lower portion thereof along which the berry-picking units are slid against or near the ground. In one embodiment, the berry-picking units are carried by two laterally opposite chains which are wrapped around respective non-circular chain guides and driven by sprockets. Sliding the berry-picking units against, or adjacent to, the ground in the substantially horizontal lower portion of the berry-picking path can yield a better berry-picking efficiency than what was previously achieved by rotating berry-picking combs in a circular motion around a horizontal axis.

In accordance with one aspect, there is provided a method for harvesting berries with a low-bush berry harvester that has a plurality of elongated berry-picking units, the method comprising: while moving the harvester in a longitudinal direction over the ground, simultaneously
carrying the elongated berry-picking units cyclically around a non-cylindrical closed-loop berry-picking path having a relatively straight lower portion during which the berry-picking units are slid against the ground, thereby picking and collecting berries, and an upper portion,
maintaining the berry-picking units spaced apart from one another along the berry-picking path, and
rotating the berry-picking units around an axis lengthwise thereto, thereby dropping the collected berries, when the berry-picking units are being carried in the upper portion of the picking path.

In accordance with another aspect, there is provided a low-bush berry harvesting system comprising a frame movable in a longitudinal direction, the frame having two transversally spaced-apart guiding sub-systems each carrying a respective closed driving loop, a plurality of elongated berry-picking units extending transversally between the two closed driving loops and each rotatably mounted to the closed driving loops at each opposite end thereof for rotation about a transversal axis, each berry-picking units having a corresponding comb for picking berries, the closed driving loops generally describing a closed-loop berry-picking path along which they can carry the rotation axes of the berry-picking units, the berry-picking path having a lower, relatively straight and horizontal portion, the berry-picking units being spaced apart from one another along the berry picking path, and a rotating sub-systems configured and adapted for rotating the berry-picking combs around the respective rotation axes thereof as they are being carried along the berry-picking path by the closed driving loops such that, during use of the system, the combs of the berry-picking comb units are maintained in a forward-facing, generally horizontal orientation along the relatively straight and horizontal portion of the berry-picking path to pick berries, and are at least partially rotated in an upper portion of the berry-picking path to empty the picked berries.

In accordance with another aspect, there is provided a low-bush berry harvester that has a plurality of elongated berry-picking units interspaced and movable along a closed-loop berry-picking path, characterized in that the berry-picking path is non-circular and has a relatively straight lower portion in which the berry-picking units are slidable against the ground to pick berries, and in that the berry-picking units are partially rotated around a lengthwisely oriented axis, in an upper portion of the berry-picking path, to drop picked berries for collection.

In accordance with another aspect, there is provided a low-bush berry harvester that has a plurality of interspaced berry-picking units cyclically carried along a closed-loop berry-picking path and each effecting one complete 360° rotation around a transversal axis thereof during each cycle, characterized in that the berry-picking units are pivotable along the transversal axis independently of their being carried along the berry-picking path, slidable against the ground to pick berries in a lower portion of the berry-picking path, and in that the rotation of the receptacles is concentrated in an upper portion of the berry-picking path, where picked berries are dropped from the receptacles and collected.

In accordance with another aspect, there is provided a low-bush berry harvesting system comprising a frame movable in a longitudinal direction, the frame having two transversally spaced-apart chain guides each associated with respective sprockets, each chain guide and associated sprockets carrying a respective guide chain, a plurality of elongated berry-picking units extending transversally between the two chains and each rotatably mounted to the guide chains at each opposite end thereof for rotation about a transversal axis, the berry-picking units each having a comb portion for picking berries and a receptacle portion for supporting the picked berries during picking, the guide chains generally describing a closed-loop berry-picking path along which the rotation axes of the berry-picking units are carried, the berry-picking units being spaced apart from one another along the berry picking path, and rotation guides fixed to the frame configured and adapted to rotate the berry-picking combs by abutment thereagainst during use of the device as they are being carried along the berry-picking path by the guide chains, wherein, during use of the device, combs of the berry-picking units are maintained in a forward-facing generally horizontal orientation along a generally linear distance in a lower portion of the berry-picking path to pick berries and are partially rotated to empty the picked berries in an upper portion of the berry-picking path.

In accordance with another aspect, there is provided A low-bush berry harvester for displacement in a longitudinal orientation, the harvester comprising a plurality of transversally-extending elongated berry-picking units rotatably mounted to two transversally opposite closed driving loops in an equally interspaced manner along the driving loops, the driving loops being guidingly mounted on a frame, each berry-picking unit having two opposite transversal ends bearing a respective rotational connection to a corresponding driving loop, a berry-picking portion longitudinally opposite a receptacle portion, a transversally-extending center of gravity axis offset from the rotational connections toward the receptacle portion, and a cam member transversally extending from one of the transversal ends along a cam axis offset from the rotational connections toward the receptacle portion, and a transversally-extending berry-receiving element positioned between the driving loops, the driving loops being capable of cyclically moving the receptacles along a closed berry-picking path having a lower portion where the receptacles are slid against the ground with the berry-picking portion facing a forward direction to collect low-bush berries, a front portion where the berry-picking units are successively raised from the ground while the cam member abuttingly slides along a first cam surface provided on the frame and which maintains the berry-picking portion generally oriented toward the front by limiting the pivoting of the receptacles under the action of gravity, an upper portion where the berry-picking units are carried into abutment against a second cam surface provided on the frame which pivots the receptacles to discharge collected berries onto the transversally-extending berry-receiving element and where the center of gravity axis is pivoted over and around the rotational connection, and a rear portion where the berry-picking units are lowered to the ground while the cam member abuttingly slides along a third cam surface provided on the frame and which maintains the berry-picker portion oriented toward the front by limiting the pivoting of the receptacles under the action of gravity prior to the receptacles landing against the ground.

The harvester can be embodied as a unit for use carried by a vehicle such as a tractor, in the front or on the side thereof, and can be embodied as part of a specialized berry-picking vehicle.

### DESCRIPTION OF THE FIGURES

Further features and advantages will become apparent from the following detailed description, taken in combination with the appended figures, in which:

FIG. 1 is a schematic side elevation view of an example of an improved low-bush berry harvester in use, carried by a vehicle;

FIG. 2 is a front perspective view of the blueberry harvester of FIG. 1 with two berry-picking units removed;

FIG. 3 is a perspective view showing one of the berry-picking units in greater detail;

FIG. 4 is a perspective view showing a side plate of the blueberry harvester of FIG. 1 without the berry-picking units;

FIG. 5 is a view similar to FIG. 4 with showing the position of the berry-picking units;

FIG. 6 is a front elevation view, fragmented, showing the connection between a berry-picking unit and a side plate; and

FIGS. 7A to 7D are side elevation views showing successive positions of the berry-picking units along the berry-picking path.

### DETAILED DESCRIPTION

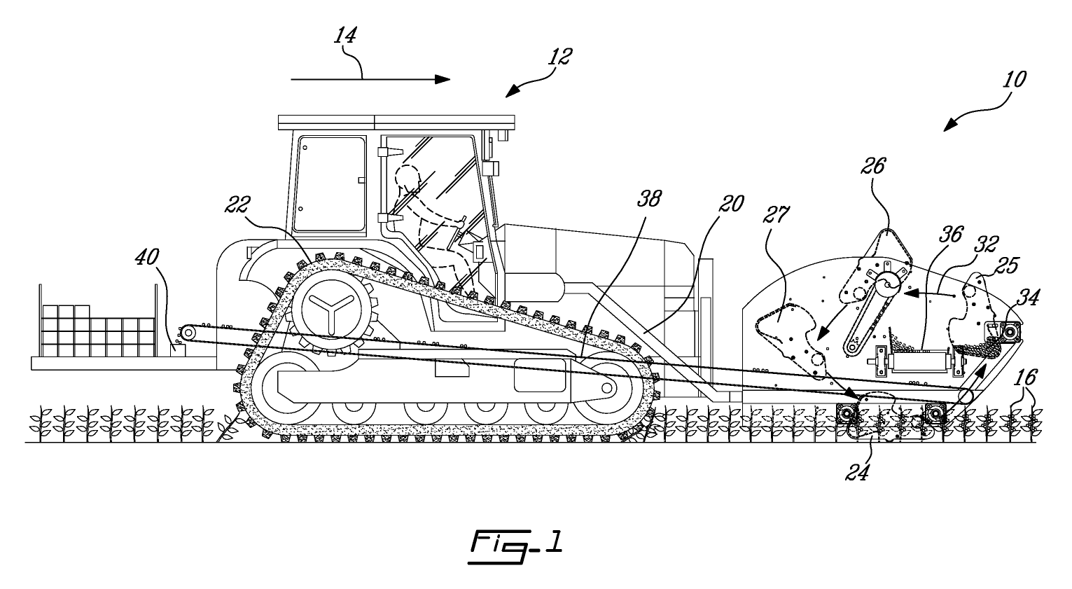

FIG. 1 shows an example of a harvester 10. In this example, the harvester 10 is specifically adapted for harvesting blueberries, and is provided as a unit carried by a tractor 12. The tractor is moving in a longitudinal orientation 14 and carries the blueberry harvester 10 over blueberry bushes 16. In this example, the blueberry harvester 10 is carried by a fork 20 of the tractor 12. When picking wild blueberry bushes, it is preferable that the tractor 12 have flat tracks 22 instead of wheels, to reduce potential damage to the blueberry bushes 16 as the tractor 12 is displaced on them. The blueberry harvester 10 includes four berry-picking units 24, 25, 26, 27, rotatably mounted between two closed driving loops defining a berry-picking path 32. Henceforth, there are two main subsystems included in the harvester: two-spaced apart guiding subsystems which receive, carry, and guide the driving loops, and thereby determine the shape of the closed berry-picking path 32; and a rotation subsystem which controls the attitude of the berry-picking units 24, 25, 26, 27 as they travel along the berry-picking path 32 by controlling the rotation of the berry-picking units 24, 25, 26, 27 along their transversal rotation axes which are displaced along the berry-picking path 32. In the illustrated embodiment, the driving loops are driven in a counter-clockwise orientation 30 to carry the berry-picking units 24, 25, 26, 27 along the berry-picking path 32, thereby carrying the berry-picking units 24, 25, 26, 27 in a forward-facing direction as they are slid against the ground. In operation, picked blueberries 34 are dropped onto a transversal conveyor 36 where they are transversally carried and dropped onto a longitudinal conveyor 38. The longitudinal conveyor 38 carries the picked berries to the rear of the vehicle 12 where they are placed into baskets 40.

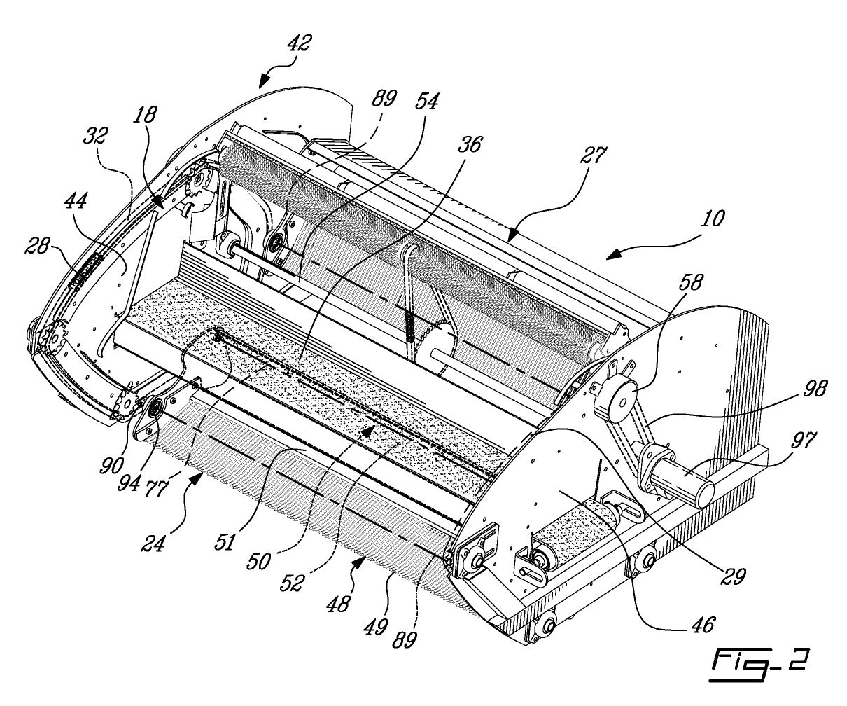

FIG. 2 shows the blueberry harvester 10 in greater detail. In this example, the harvester 10 has a frame 42 with two opposite side plates 44, 46. It will be noted that, in FIG. 2, two of the four berry-picking units have been removed to increase clarity. The two remaining berry-picking units 24, 27 are illustrated. In this example, the driving loops used to drive the berry-picking units 24, 27 are loop chains 28, 29. The berry-picking units 24, 27 are rotatably mounted to the loop chains 28, 29 so as to be both rotatable around a transversal rotation axis 89 coinciding with the axis of a rotational connection 94 to the loop chain 28, and displaceable to be carried along the berry-picking path 32 by the loop chains 28, 29. The loop chains 28, 29 are mounted to the frame 42 via a guiding subsystem 18 which defines the shape of the path along which the rotation axes 89 of the berry-picking units 24, 27 are carried. In this embodiment, the guiding susbsystem 18 includes a plurality of chain guides and sprockets, the details of which will be described further below. A transversal conveyor 36 extends transversally between and through the two opposite side plates 44, 46. Each berry-picking unit 24, 27 is similar.

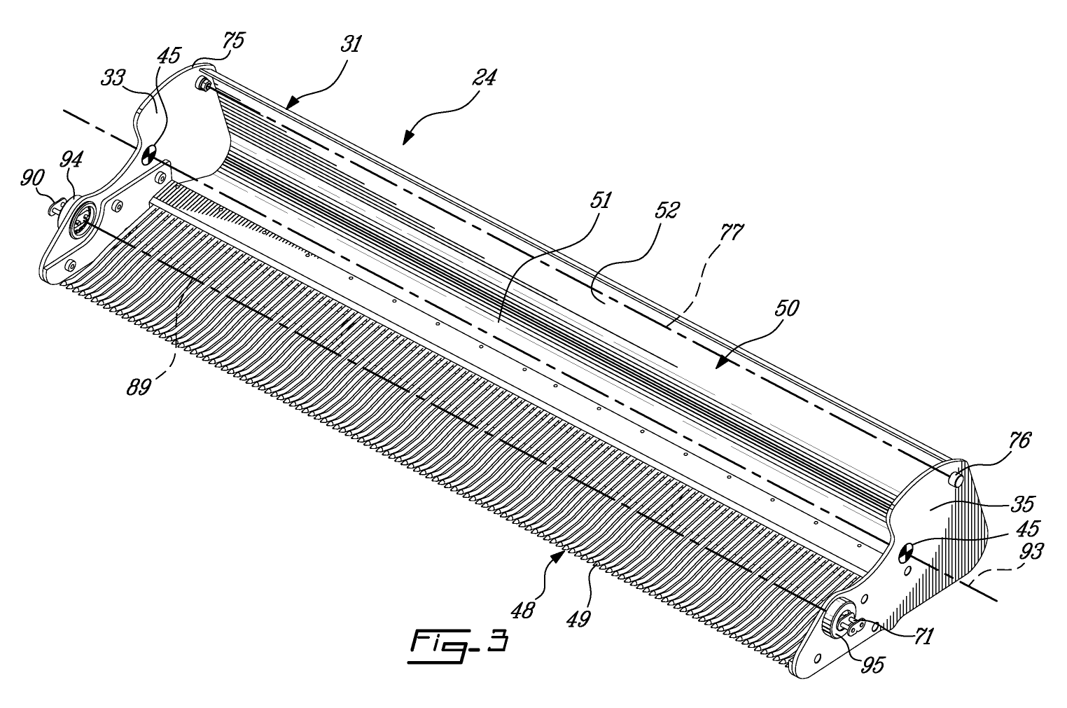

As best viewed in FIG. 3, the berry-picking unit 24 has a body 31 having a front berry-picking portion 48 having a berry-picking comb 49, and a rear receptacle portion 50 generally shaped as an L and having a front flange 51 connected to the comb 49 and a rear flange 52 substantially perpendicular to the front flange 51. A respective side member 33, 35 is provided on each side of the body 31. The berry-picking unit 24 has two rotatable chain links 90, 71, one at each opposite end thereof. Each chain link 90, 71 is affixed to an extension which is journaled in the respective side member 33, 35 of the berry-picking unit 24, thereby providing respective rotational connections 94, 95 between the berry-picking unit 24 and the loop chains 29, 28 (FIG. 2). The chain links 90, 71 are assembled to the loop chains 28, 29, thereby providing means by which the berry-picking unit can be carried by the loop chains 28, 29, whereas the rotational connections 94, 95 allow the berry-picking unit 24 to be rotated around a transversal rotation axis 89 independently of the direction in which it is carried by the loop chains 28, 29. The center of gravity 45 of the berry-picking unit 24, or more particularly the transversal axis 93 coinciding with the center of gravity of the berry-picking unit 24, is offset from the transversal rotation axis 89 toward the rear. The rear end, or receptacle portion 50 of the berry-picking unit 24, thereby tends to fall downwardly under the action of gravity when the berry-picking unit 24 is held at its rotational connections 94, 95. As it will be discussed in greater detail below, this falling tendency of the berry-picking unit 24 is controlled and harnessed using camming surfaces associated with the frame 42 of the harvesting system, to maintain the combs 49 forwardly aligned along a given distance in the lower portion of the berry-picking path 32, and to concentrate the rotation of the berry-picking units in an upper portion of the path 32, over the transversal conveyor 36, where it can empty the receptacle portions 50 from picked blueberries onto the transversal conveyor 36. Toward the rear of the berry-picking unit 24, two cam pins 75, 76 extend transversally therefrom along a cam axis 77, the use of which will be described further below. The berry-picking units 24, 25, 26, 27 being essentially identical to one another, only one is described in detail.

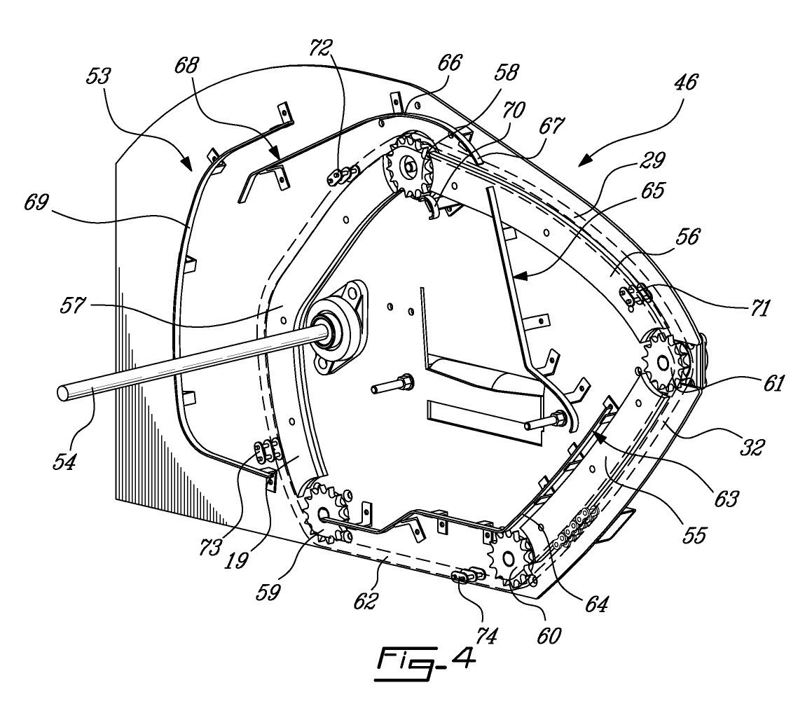

FIG. 4 shows the arrangement of the right side plate 46 in further detail. The two opposite side plates 44, 46 are essentially mirror images of one another and therefore only the right side plate 46 will be described in detail. The loop chain 29 is mounted around a plurality of chain guides 55, 56, 57 and sprockets 58, 59, 60, 61 which together form a guiding subsystem 19 defining the path of the loop chain 29, and thereby a traveling path of the rotation axis 89 of the berry-picking unit 24. The position of the chain links 71, 72, 73, 74 corresponding to the rotational connection 95 of each one of the berry-picking units 24, 25, 26, 27 is shown. In this example, there is absence of a chain guide in the lower portion 62 of the loop chain 29, this affords the berry-picking units 24, 25, 26, 27 a certain vertical degree of freedom to adapt to bumps and other irregularities as they are slid against the ground. This feature is particularly useful for picking wild blueberries which are often on uneven terrain. In this embodiment, one of the sprockets is a drive sprocket 58 and the others are idle sprockets 59, 60, 61.

Referring back to FIG. 2, a drive motor 97 is geared with the drive sprocket 58 by means of a chain 98. In this embodiment, the drive motor 97 is mounted to a drive shaft 54 which transversally extends across the two side plates 44, 46 of the harvester 10. On the left side (not shown), the drive shaft 54 is also similarly geared with the corresponding drive sprocket by means of a chain, and both loop chains 28, 29 are thereby driven simultaneously.

Referring to FIG. 4, a berry-picking unit rotation subsystem 53 is used to guide the rotation of the berry-picking units 24, 25, 26, 27 (FIG. 2) as they are carried by the loop chain 29 along the berry-picking path 32. In this embodiment, the rotation subsystem 53 includes: a front pin guide 63 having a first camming surface 64; an upper pin guide 65 provided in two parts, having a corresponding two-part camming surface 66 with a discontinuity 67 where it intersects the path of the loop chain 29 to allow passage of the rotational connection 95 of the berry-picking units 24, 25, 26, 27; and a rear pin guide 68 having a corresponding camming surface 69, all of which are fixedly mounted to the side plate 46. The camming surfaces 64, 66, 69 are engaged by the transversally extending cam pin 76, and thereby control the attitude, or rotation, of the berry-picking receptacles. In this embodiment, a berry-picking unit body cam 70 is also used. The body cam 70 comes into abutment against a side member 35 of the body 31 of the berry-picking unit 24 to move the cam pin 75 (FIG. 3) across the gap 67 in the upper pin guide 65, against the falling tendency caused by gravity. The body cam 70 also forms part of the rotation subsystem and is mounted on the side plate 46.

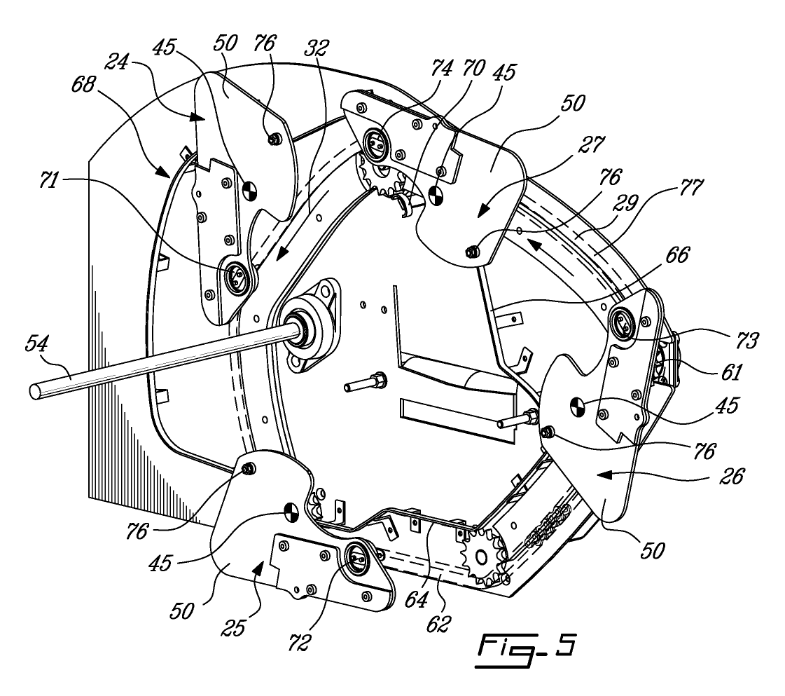

FIG. 5 schematically illustrates the position of the berry-picking units 24, 25, 26, 27, along the loop chain 29 which coincides with the berry-picking path 32. The berry-picking units 24, 25, 26, 27 have a center of gravity 45 which is offset from the rotational connection 95 of the chain links 71, 72, 73, 74. In this case, the center of gravity 45 is offset toward the rear, or receptacle portion 50, of the berry-picking units 24, 25, 26, 27. Therefore, when no external force is applied to the berry-picking units 24, 25, 26, 27, the receptacle portion 50 tends to pivot about the rotation axis 71, 72, 73, 74 toward the ground due to the action of gravity. The cam pin 76 extends transversally at the rear portion 50, and this pivoting tendency can be controlled with the pin guide camming surfaces 64, 66, 69 which provide support to the cam pin 76 during corresponding portions of the berry-picking path 32.

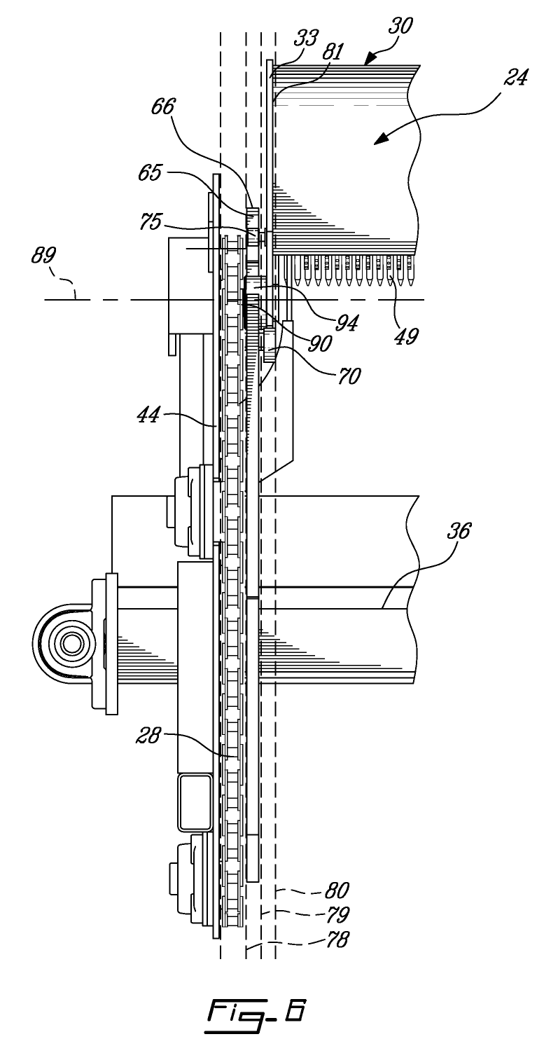

As can be understood more clearly from FIG. 6, there are thus three levels of interaction between the components on the side plate 44 and each berry-picking unit (24). A first level of interaction is between the berry-picking unit 24 and the loop chain 28. The chain link 90 which forms part of the rotational connection 94 of the berry-picking unit 24 is shown assembled to the loop chain 28. It is the loop chain 28 which carries the berry-picking unit 24 along the berry-picking path while the berry-picking unit 24 is free to rotate about the rotation axis 89. The loop chain 28 is confined on the chain guides and sprockets within a first depth 78. On the berry-picking unit 24, only the chain link 90 extends into the first depth.

A second level of interaction is between the berry-picking units and the pin guides 63, 65, 68 (only the upper pin guide 65 is shown in FIG. 5). The pin guides 63, 65, 68 each have a camming surface 64, 66, 69 which extend inwardly from the side plate 46 and loop chain 28, between the first depth 78 and a second depth 79. In use, the camming surface 66 abuts against the cam pin 75 which extends transversally from the rear of the body 30 of the berry-picking unit 24 into the second depth 79. The camming, or sliding abutment of the cam pin 75 against the camming surface 66 can exert a rotating force on the berry-picking unit 24 around the rotation axis 89, which counteracts the rotating force which can result from gravity acting on the center of gravity of the unit 24, thereby serving to control and harness the falling rotation tendency of the berry-picking unit 24.

A third level of interaction used in the present embodiment is between the unit body guide 70 which extends past the side plate 46, the loop chain 28, and the pin guides 63, 65, 68, to a third depth 80. The body 30 of the berry-picking unit extends into the third depth 80. The body guide 70 can thus engage the body 30 of the berry-picking unit 24 directly.

Henceforth, the berry-picking unit 24 is rotatably mounted loop chain 28 at the chain link 71. The chain 28 is confined within at a first depth 78. The cam pin 76 extends transversally from a transversal end 81 of the receptacle 24. The cam pin 76 is shorter than the chain pin 71 and does not extend beyond the first depth 78. The pin guide 65 extends from the side plate 46 up to a second depth 79 sufficient for it to abut against, and to slidingly receive, the cam pin 76. The unit body cam 70 projects to a third depth 80 which is sufficient to engage the body 31, or more particularly to a side member 33, of the berry-picking unit 24 at one end 81 thereof.

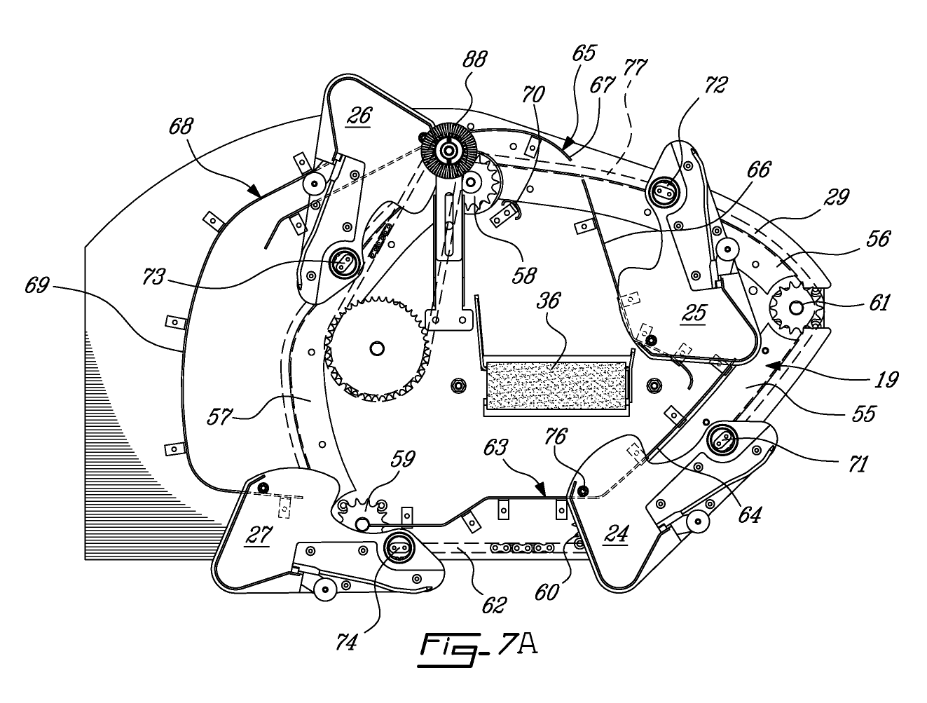

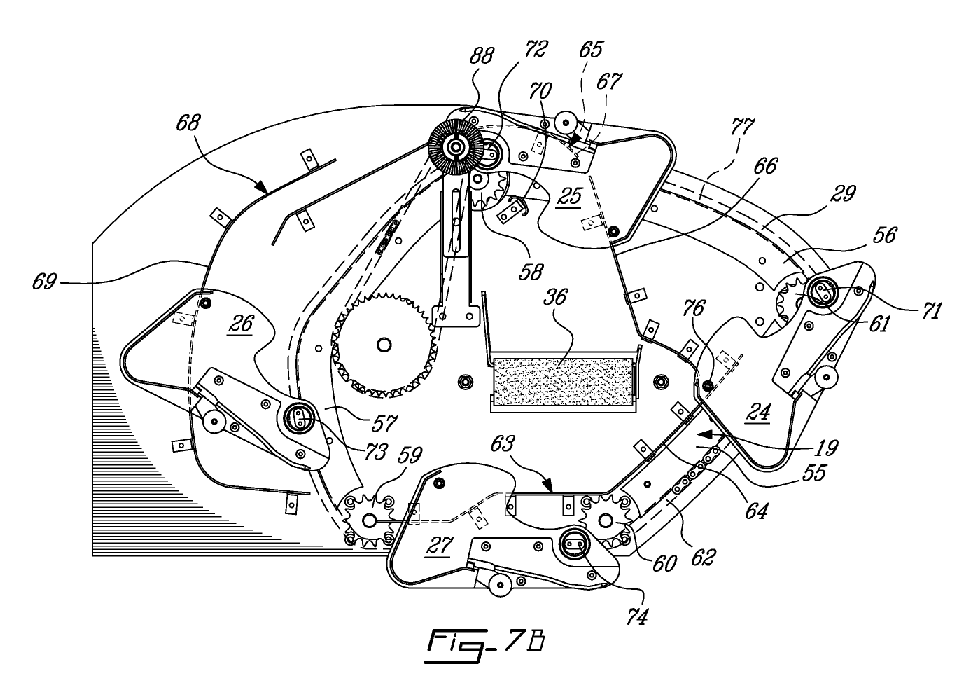

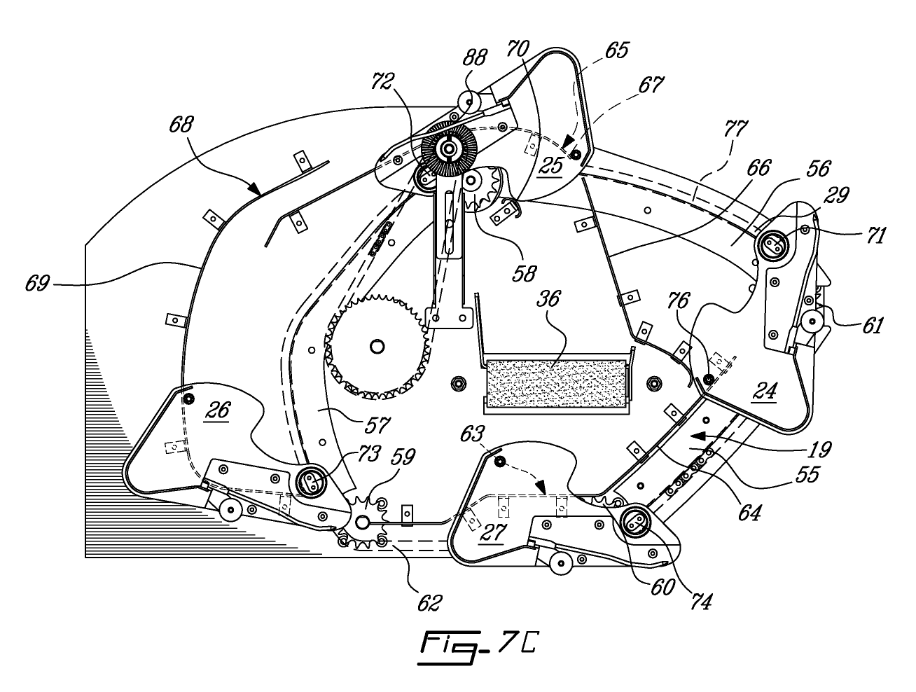

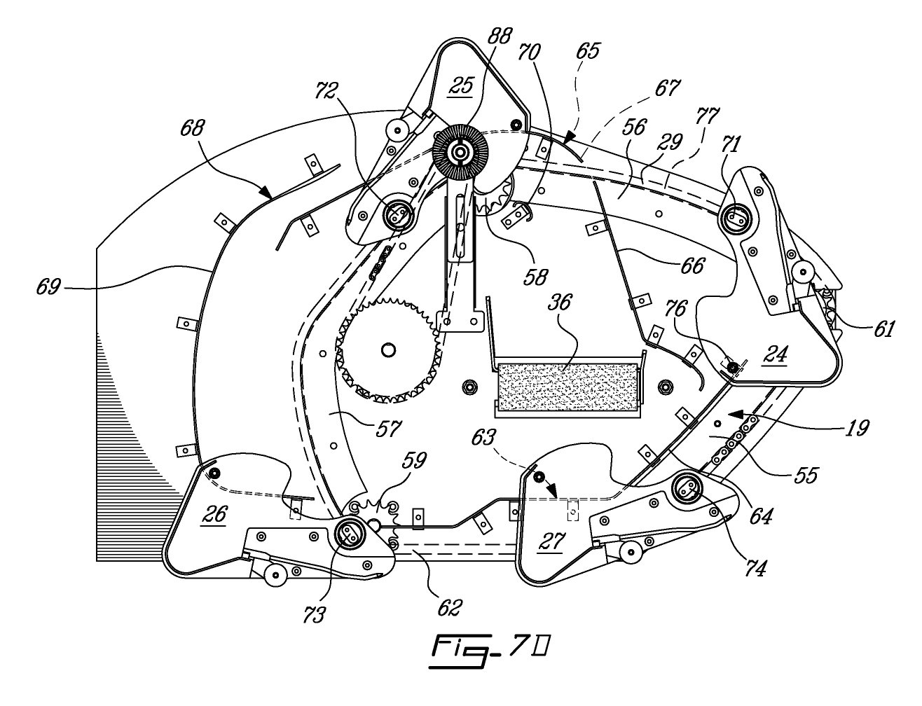

FIGS. 7A to 7D schematically depict the harvester in operation by showing several successive positions of the berry-picking units 24, 25, 26, 27 being carried by the loop chain 28 in an equally interspaced fashion from one another. The berry-picking units 24, 25, 26, 27 are slid against the ground as they are pulled by the loop chain 28 in a lower portion 62 of the berry-picking path. When they reach a front portion of the lower portion 62 of the berry-picking path 32, the cam pin 76 engages the camming surface 64 and the berry-picking unit 24 is raised by the loop chain 29 while the rear portion 50 of the berry-picking unit 24 is kept from pivoting by the cam pin 76 which abuts the camming surface 64. When carried around to the front sprocket 61 (FIG. 7B), the rear portion 50 of the receptacle 26 tends to pivot downwardly but in this example, the center of gravity 45 is positioned in a manner that this is not sufficient for the berries to fall out from the receptacle portion 50. As the chain link 71, which connects the berry-picking unit 24, is moved along an upper portion 81 of the berry-picking path 32, the cam pin 76 engages the camming surface 66 of the upper pin guide 65, which forces the receptacle 24 to partially rotate sufficiently to empty the berries onto the transversal conveyor 36. The camming surface 66 then continues to pivot the berry-picking unit 26 up to a point where the center of gravity 45 of the receptacle 27 is toppled over the chain link 71 and toward the rear of the harvester, and then gravity continues the pivoting movement and the guide pin 76 engages the camming surface of the rear pin guide 68 (transition between FIGS. 7A and 7B). The rear pin guide 68 limits the pivoting of the receptacle 26 to position the receptacle in a proper angle, or attitude, for it to be correctly aligned when it is lowered to the ground (FIGS. 7B to 7D). It will be understood that the cam pin 76 transversally projects or extends a certain distance sufficient for it to engage the pin guides 63, 65, 68, but not too much, to avoid interference with the chain loop 29. The pivoting passage of the berry-picking unit 25 across the discontinuity 67 in the upper pin guide 65 (transition between FIGS. 7B and 7C) is assured in this case by the body cam 70 which abuts against the body 30 of the berry-picking unit 25. The discontinuity 67 is present in the upper pin guide 65 to allow the chain link 72 and its rotational connection to pass through the upper pin guide 65 (transition between FIGS. 7A and 7B). Each berry-picking unit 24, 25, 26, 27 is thus slid against the ground a predetermined distance before being raised therefrom.

For illustrative purposes, in the illustrated example of the blueberry harvester, the height of the harvester is of about 40 inches and the width is of about 50 inches, and the distance during which the receptacles are slid against the ground is of about 18 inches. Also as can be seen, the distance between the successive receptacles 24, 27 along the chain 29 is such that when one receptacle 24 begins to be raised by the chain 29, a successive receptacle 27 is placed in position and ready to receive oncoming berry bushes (see FIG. 7A).

In the illustrated embodiment, a comb brush 88 is used to free the berry picking comb 49 from remaining leaves or twigs which could have been picked up from the blueberry bushes as the berry-picking unit 24 passes across it. In this example, the brush 88 acts on the comb 49 while the receptacle 24 is upside down. In this embodiment, the brush 88 is rotatable and geared to the drive shaft 54, though a non-rotary brush can alternately be used. The brush may be omitted in certain embodiments.

As it can be seen therefore, in comparison to the prior art discussed above, in the improved blueberry harvester, the berry-picking combs do a 360° rotation for each cycle, but in this case, the berry-picking units are rotatably mounted to a driving loop which allows to slide the receptacles and the berry-picking units against the ground in a lower portion of the berry-picking path and to concentrate most of the 360° rotation of the berry-picking units in an upper portion of the berry-picking path, where blueberries can be emptied from the berry-picking units.

In this example, the drive motor 97 can be a variable speed motor. In use, when the harvester 10 is being carried by a tractor 12, as shown in FIG. 1, the tractor operator can thus vary the speed of tractor in the longitudinal direction 14, and can also vary the speed at which the berry-picking units 24. 25, 26, 27 travel along the berry picking path 32. The speed at which the berry-picking unit 24 is slid against the ground is the sum of the speed of the tractor 12, and the speed imparted to the berry-picking unit 24 along the berry picking path 32 by the driving loops 28. Depending on the density of blueberries on the field, the speed of the tractor can thus be adjusted while maintaining the speed at which the berry-picking unit 24 is slid against the ground by adjusting the speed of the variable speed drive motor 84 of the driving loops 28. Typically, the travelling speed of the loop chains 28 is adjusted first, and the speed of the carrying vehicle is then adjusted.

The tractor 12 which is used to carry the harvester 10 can advantageously have an operator cabin configured and adapted to allow the operator to have visual access to the berry-picking unit 24 being slid against the ground in the lower portion of the berry-picking path. He can thus visually witness the rate at which the berry-picking unit 24 is being filled by blueberries and adjust the speed of the tractor and of the drive motor accordingly. For instance, if the field has a low density of blueberries, the operator can slow down or even stop the drive motor 97 of the berry-picking units, and increase the vehicle speed to enhance berry-picking efficiency. The same berry-picking unit 24 can thus be slid against the ground until it is satisfyingly filled with berries, which can advantageously minimize the amount of manipulation of the berries, instead of successively using two or more only partly filled berry-picking units. When the berry field has a high concentration of berries, the operator can lower the speed of the vehicle, and increase the speed of the berry-picking units 24, 25, 26, 27 along the berry-picking path 32 until the berry-picking units are each successively filled with a satisfactory amount of berries, and not too many berries, which could result in spillage of berries.

In the example illustrated, the blueberry harvester 10 is particularly adapted to be carried by a vehicle such as a tractor, as illustrated in FIG. 1. However, it will be understood that in alternate embodiments, the harvester can be made a size allowing it to be manually displaced and mounted on wheels, similarly to a snow-blower, for example. Alternately, the drive loops can be geared to the rotation of the wheels and the drive motor can be omitted. The harvester can also be made part of a vehicle in alternate embodiments.

Using the transversal conveyor allows to continuously remove the blueberries which are dropped thereon. However, in alternate embodiments, it can be suitable to omit the transversal conveyor and to position a blueberry container at a similar location instead.

In alternate embodiments, the rotation subsystem described above can be replaced with alternate means to control the rotation of the berry-picking units. For example, the in an alternate embodiment, the berry-picking units can have integrated motors to drive the rotation at predetermined locations on the berry-picking path.

In the illustrated example, the driving loops which carry the berry-picking units are loop chains, which advantageously present low-elasticity and sturdiness advantageous in this application. However it will be understood that the drive loop can alternately be a toothed belt or another equivalent. Concerning the guiding subsystem which is used to guide the loop chains in the above-described embodiment, it will be understood that different shapes and configurations of guides and/or sprockets can be used in alternate embodiments. A different guiding subsystem can be used to adapt to a different driving loop, for example. The particular shape of the berry-picking path can also vary in alternate embodiments.

The berry harvester 10 illustrated is particularly well suited for picking low bush blueberries, however it will be understood that it can be adapted to pick other types of low bush berries, such as cranberries for example. In the example given above, a cam pin acts as a cam member of the berry-picking unit which engages camming surfaces of the pin guides. This configuration can be modified and equivalents to a cam pin can be used.

In the example given above, four berry-picking units are used and equally interspaced along the chain guides. Equally interspacing along the chain guide is not an absolute requirement, there can be some range of tolerance in the relative interspacings. Also, more or less than four berry-picking units can be used. Using four berry-picking units in the configuration illustrated allows the berry-picking units to be sufficiently interspaced to be free from interference with one another during the various rotation stages of the berry-picking path, and to be sufficiently close to one another for a subsequent berry-picking unit to be readied against the ground as a previous berry-picking unit is beginning to be raised.

Concerning the berry-picking units themselves, in alternate embodiments, the relative positions of the rotation axis, center of gravity axis, and cam pin axis can vary.

As can be seen therefore, the examples described above and illustrated are intended to be exemplary only. The scope of the invention(s) is intended to be determined solely by the appended claims.

What is claimed is:

1. A method for harvesting berries with a low-bush berry harvester that has a plurality of elongated berry-picking units, the method comprising:
while moving the harvester in a longitudinal direction over the ground, simultaneously
carrying the elongated berry-picking units cyclically around a non-cylindrical closed-loop berry-picking path having a relatively straight lower portion during which the berry-picking units are slid against the ground, thereby picking and collecting berries, and an upper portion,
maintaining the berry-picking units spaced apart from one another along the berry-picking path; and
rotating the berry-picking units around an axis lengthwise thereto, thereby dropping the collected berries, when the berry-picking units are being carried in the upper portion of the picking path.

2. The method of claim 1 further comprising conveying the dropped berries away from the berry-picking path.

3. A low-bush berry harvesting system comprising a frame movable in a longitudinal direction, the frame having two transversally spaced-apart guiding sub-systems each carrying a respective closed driving loop, a plurality of elongated berry-picking units extending transversally between the two closed driving loops and each rotatably mounted to the closed driving loops at each opposite end thereof for rotation about a transversal axis, each berry-picking units having a corresponding comb for picking berries, the closed driving loops generally describing a closed-loop berry-picking path along which they can carry the rotation axes of the berry-picking units, the berry-picking path having a lower, relatively straight and horizontal portion, the berry-picking units being spaced apart from one another along the berry picking path, and a rotating sub-systems configured and adapted for rotating the berry-picking combs around the respective rotation axes thereof as they are being carried along the berry-picking path by the closed driving loops such that, during use of the system, the combs of the berry-picking comb units are maintained in a forward-facing, generally horizontal orientation along the relatively straight and horizontal portion of the berry-picking path to pick berries, and are at least partially rotated in an upper portion of the berry-picking path to empty the picked berries.

4. The system of claim 3 wherein the closed driving loops are chains.

5. The system of claim 4 wherein the guiding sub-systems each include chain guides and sprockets mounted to the frame and carrying the corresponding chain, and arranged in a manner to maintain the chains in a configuration corresponding to the berry-picking path.

6. The system of claim 5 wherein at least one of the sprockets of each guiding sub-system is a drive sprocket driving the corresponding chain.

7. The system of claim 3 wherein the berry-picking units each have a receptacle portion for receiving the berries picked by the comb.

8. The system of claim 3 wherein the rotation sub-system has rotation guides fixedly mounted to the frame and positioned in a manner to guide the rotation of the berry-picking units by abutment thereagainst as the berry-picking units are carried along the berry-picking path.

9. The system of claim 8 wherein the berry-picking units have a center of gravity off-centered from the rotation axes thereof, gravity thereby also partially causing the rotation of the berry-picking units in cooperation with the rotation guides.

10. The system of claim 8 wherein the berry-picking units have a transversally extending cam pin configured and adapted for engaging into said abutment with the rotation guides.

11. The system of claim 10 wherein the rotation guides have cam pin guides configured and adapted for said abutment with said cam pins, and a berry-picking unit body guide extending transversally past the cam pin guides from the frame, and configured and adapted for engaging with a body of the berry-picking units to complete said rotation thereof as the berry-picking units are carried along the berry-picking path.

12. The system of claim 3 further comprising means for driving the closed driving loops.

13. The system of claim 3 wherein the frame has two opposite side plates, each one of the closed driving loops being drivingly mounted on a corresponding side plate.

14. The system of claim 3 further comprising a transversally-extending drive shaft rotatably mounted to the frame and geared with both closed driving loops for driving both closed driving loops simultaneously.

15. The system of claim 3 further comprising a conveyor extending transversally between the closed driving loops, and positioned for receiving berries which are dropped by the berry-picking units in the upper portion of the berry-picking path.

16. The system of claim 3 further comprising a transversally extending brush positioned in an upper portion of the berry-picking path in a manner to intersect the passage of the combs, thereby cleaning the combs, as the berry-picking units are being carried in the upper portion of the berry-picking path.

17. The system of claim 16 wherein the brush is a rotary brush driven in rotation.

18. The system of claim 3 wherein the frame is configured and adapted for being lifted and carried in a longitudinal direction by a vehicle.

19. The system of claim 3 provided as part of a vehicle.

20. A low-bush berry harvester for displacement in a longitudinal orientation, the harvester comprising a plurality of transversally-extending elongated berry-picking units rotatably mounted to two transversally opposite closed driving loops in an equally interspaced manner along the driving loops, the driving loops being guidingly mounted on a frame, each berry-picking unit having two opposite transversal ends bearing a respective rotational connection to a corresponding driving loop, a berry-picking portion longitudinally opposite a receptacle portion, a transversally-extending center of gravity axis offset from the rotational connections toward the receptacle portion, and a cam member transversally extending from one of the transversal ends along a cam axis offset from the rotational connections toward the receptacle portion, and a transversally-extending berry-receiving element positioned between the driving loops, the driving loops being capable of cyclically moving the receptacles along a closed berry-picking path having a lower portion where the receptacles are slid against the ground with the berry-picking portion facing a forward direction to collect low-bush berries, a front portion where the berry-picking units are successively raised from the ground while the cam member abuttingly slides along a first cam surface provided on the frame and which maintains the berry-picking portion generally oriented toward the front by limiting the pivoting of the receptacles under the action of gravity, an upper portion where the berry-picking units are carried into abutment against a second cam surface provided on the frame which pivots the receptacles to discharge collected berries onto the transversally-extending berry-receiving element and where the center of gravity axis is pivoted over and around the rotational connection, and a rear portion where the berry-picking units are lowered to the ground while the cam member abuttingly slides along a third cam surface provided on the frame and which maintains the berry-picker portion oriented toward the front by limiting the pivoting of the receptacles under the action of gravity prior to the receptacles landing against the ground.
